(19) United States
(12) Patent Application Publication
(10) Pub. No.: US 2005/0174040 A1
(43) Pub. Date: Aug. 11, 2005

(54) Field emission backlight device

(76) Inventors: Jae-Eun Jung, Seoul (KR); Jong-Min Kim, Suwon-si (KR); Young-Jun Park, Suwon-si (KR); Hang-Woo Lee, Suwon-si (KR)

Correspondence Address: Robert E. Bushnell;Attorney-at-Law, Suite 300, 1522 'K' Street, N.W., Washington, DC, 20005-1202, US

(21) Appl. No.: 11/046,713

(22) Filed: Feb. 1, 2005

(30) Foreign Application Priority Data
Feb. 5, 2004 (KR) 10-2004-0007526

(51) Int. Cl. H01J 1/02; H01J 5/16

(52) U.S. Cl. 313/495; 313/309; 313/110

(57) ABSTRACT

A field emission backlight device includes: a front substrate and a rear substrate arranged in parallel and spaced apart from each other by a predetermined distance; an anode and a cathode arranged opposite to each other on a respective inner surfaces of the front and rear substrates; a fluorescent layer arranged on the anode and having a predetermined thickness; a convex portion including a plurality of convex projections arranged on an outer surface of the front substrate opposite to the anode; and electron emitters arranged on the cathode to emit electrons in response to an applied field.

### CLAIM OF PRIORITY

This application makes reference to, incorporates the same herein, and claims all benefits accruing under 35 U.S.C. §119 from an application for FIELD EMISSION BACKLIGHT DEVICE earlier filed in the Korean Intellectual Property Office on 5 Feb. 2005 and there duly assigned Serial No. 2004-7526.

### BACKGROUND OF THE INVENTION

1. Field of the Invention

The present invention relates to a field emission backlight device and method of manufacture thereof, and more particularly, to a field emission backlight device useful in Liquid Crystal Displays (LCDs) and a method of manufacture thereof.

2. Description of the Related Art

Liquid crystal displays (LCDs) include backlight devices to generate white light on the back side thereof. In the past, cold cathode fluorescence lamps were used as backlight devices. However, backlight devices in the form of a plate were needed to provide thinner backlight devices.

In a backlight device, spacers are provided between a front substrate and a rear substrate, and walls between the front substrate and the rear substrate are sealed. A cathode is provided in the form of a plate or a stripe on the rear substrate, and electron emitters, for example, made of Carbon NanoTubes (CNTs) are formed on the cathode. An anode, which is a transparent electrode, is formed on the front substrate and a fluorescent layer is coated on the anode.

A diffuser is provided to overcome the problem that the light which passes through the front substrate is not uniform.

When a predetermined voltage is supplied between the cathode and the anode, electrons are emitted from the electron emitters to excite the fluorescent layer. The light generated from the fluorescent layer enters an LCD through the fluorescent layer, the anode, the front substrate and the diffuser.

Such plate-type backlight devices have high production costs due to the use of the diffuser. Furthermore, they have high loss of light since a portion of the light is reflected out of the active area.

Accordingly, backlight devices which emit uniform light without a diffuser are needed.

### SUMMARY OF THE INVENTION

The present invention provides a field emission backlight device having an improved luminance uniformity by arranging a convex portion on one side of its front substrate.

According to an aspect of the present invention, a field emission backlight device is provided comprising: a front substrate and a rear substrate arranged in parallel and spaced apart from each other by a predetermined distance; an anode and a cathode arranged opposite to each other on respective inner surfaces of the front and rear substrates; a fluorescent layer arranged on the anode and having a predetermined thickness; a convex portion including a plurality of convex projections arranged on an outer surface of the front substrate, opposite to the anode; and electron emitters arranged on the cathode to emit electrons in response to an applied field.

The field emission backlight device can further comprise a reflective film arranged on on the fluorescent layer to reflect light generated by the fluorescent layer towards the front substrate.

The projections can have a size of several tens μm to several tens nanometers.

The convex portion can be a film having a plurality of convex projections attached to an outer surface of the front substrate.

The reflective film can be aluminum. The reflective film can have a thickness of 500 Å.

The electron emitters can be Carbon NanoTube (CNT) materials.

According to another aspect of the present invention, a method of manufacturing a field emission backlight device is provided, the method comprising: arranging a front substrate and a rear substrate in parallel and spaced apart from each other by a predetermined distance; arranging an anode and a cathode opposite to each other on respective inner surfaces of the front and rear substrates; arranging a fluorescent layer of a predetermined thickness on the anode; arranging a convex portion including a plurality of convex projections on an outer surface of the front substrate opposite to the anode; and arranging electron emitters on the cathode to emit electrons in response to an applied field.

The method can further comprise arranging a reflective film on the fluorescent layer to reflect light generated by the fluorescent layer towards the front substrate.

The convex projections can have a size of several tens μm to several tens nanometers.

The convex portion can comprise a film having a plurality of convex projections attached to the outer surface of the front substrate.

The reflective film can be aluminum and can have a thickness of 500 Å.

The electron emitters can comprise Carbon NanoTube (CNT) materials.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a schematic cross-sectional view of the structure of a backlight device for use in a liquid crystal display (LCD);

FIG. 2 is a schematic cross-sectional view of the structure of a field emission backlight device according to an embodiment of the present invention;

FIG. 3 is a Scanning Electron Microscope (SEM) photograph of the structure of the front substrate 101 of FIG. 2;

FIGS. 4A through 4C are schematic cross-sectional views of a process of producing the front substrate according to an embodiment of the present invention; and

FIG. 5 is a graph of the experimental results showing the effect of an aluminum reflective film on the enhancement of brightness.

### DETAILED DESCRIPTION OF THE INVENTION

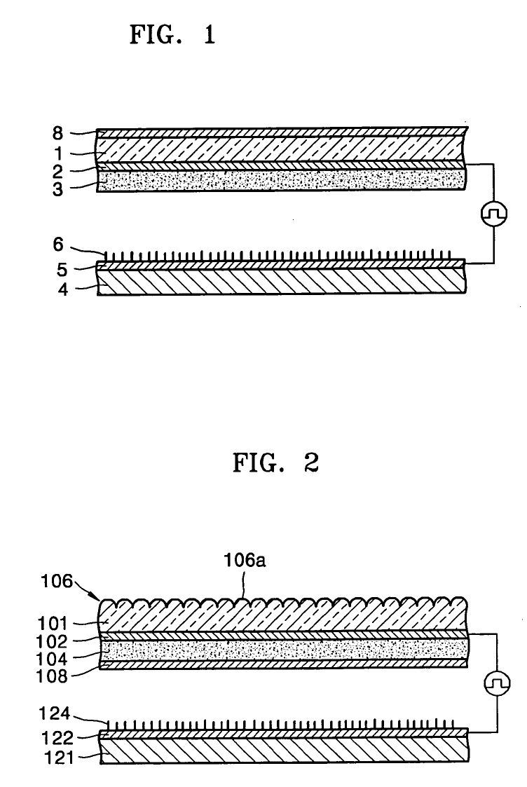

FIG. 1 is a schematic cross-sectional view illustrating the structure of a backlight device.

Referring to FIG. 1, spacers (not shown) are provided between a front substrate 1 and a rear substrate 4, and walls (not shown) between the front substrate 1 and the rear substrate 4 are sealed. A cathode 5 is provided in the form of a plate or a stripe on the rear substrate 4, and electron emitters 6, for example, made of Carbon NanoTubes (CNTs) are formed on the cathode 5. An anode 2, which is a transparent electrode, is formed on the front substrate 1 and a fluorescent layer 3 is coated on the anode 2.

A diffuser 8 is provided to overcome the problem that the light which passes through the front substrate 1 is not uniform.

When a predetermined voltage is supplied between the cathode 5 and the anode 2, electrons are emitted from the electron emitters 6 to excite the fluorescent layer 3. The light generated from the fluorescent layer 3 enters an LCD through the fluorescent layer 3, the anode 2, the front substrate 1 and the diffuser 8.

Such plate-type backlight devices have high production costs due to the use of the diffuser 8. Furthermore, they have high loss of light since a portion of the light is reflected out of the active area.

Accordingly, the development of backlight devices is required which emit uniform light without a diffuser.

Hereinafter, an embodiment of a field emission backlight device according to the present invention will be described in detail with reference to the attached drawings. In the drawings, the size of layers and zones is exaggerated for clarity.

FIG. 2 is a schematic cross-sectional view of the structure of a field emission backlight device according to an embodiment of the present invention.

Referring to FIG. 2, a front substrate 101 and a rear substrate 121 are disposed in parallel, spaced apart from each other by a predetermined distance. The front substrate 101 and the rear substrate 121 can be made of transparent materials, for example, glass. The front substrate 101 transmits light generated by a fluorescent layer 104, which will be described later. The fluorescent layer 104 is arranged on the back side of an LCD.

An anode 102, for example, an ITO transparent electrode, is arranged on the inner surface of the front substrate 101. A fluorescent layer 104 having a predetermined thickness, for example, a thickness of 10 μm, is coated on the inner surface of the anode 102. The fluorescent layer 104 is excited by electrons emitted from the electron emitters and generates visible light.

A convex portion 106 is formed on the outer surface of the front substrate 101. Convex projections 106a having a size of several tens μm to several tens nanometers are formed in the convex portion. The convex portion 106 can be formed during the process of producing the front substrate 101. Alternatively, it is possible to attach a separate film, for example, made of polyester, having convex projections 106a on its surface, to the outer surface of the front substrate 101. The projections 106a in the convex portion 106 are convex-shaped and collect the light generated by the fluorescent layer 104. Thus, the present invention reduces loss of light caused by the divergence of the light out of an active area. Also, luminance uniformity of the field emission backlight device is improved. Thus, it can eliminate the use of a diffuser.

An aluminum reflective film 108 having a thickness of 500 Å is formed on the fluorescent layer 104. The aluminum reflective film 108 reflects the light generated by the fluorescent layer 104 to the front substrate 101 to enhance the light transmittance efficiency. The aluminum reflective film 108 also serves to protect the fluorescent layer 104 from electrons emitted by the emitters.

A cathode 122 is formed on the rear substrate 121. An ITO transparent electrode can be used as the cathode 122. Emitters, for example, CNT materials 124, are formed on the cathode 122.

When a pulse voltage of 1.5 to 2.5 kV is supplied between the anode 102 and the cathode 122, electrons are emitted from CNT materials 124 on the cathode 122. The emitted electrons pass through the aluminum reflective film 108 toward the anode 102 to excite the fluorescent layer 104. Then, visible light is generated by the fluorescent layer 104. Some visible light directly passes through the front substrate 101, and other visible light is reflected by the reflective film 108 and then passes through the front substrate 101. After the light passes through the front substrate 101, the convex portion 106 changes its route so that the light is directed to the active area. This results in an improved luminance uniformity of the backlight device.

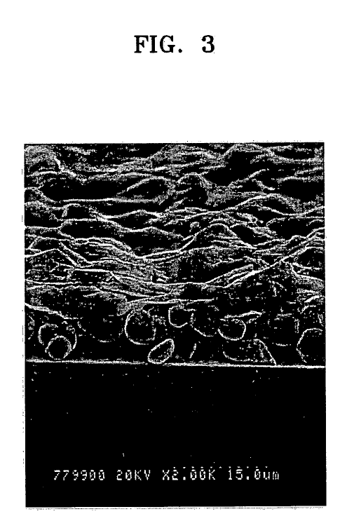

FIG. 3 is a scanning electron microscope (SEM) photograph of the structure of the front substrate 101 of FIG. 2.

Referring to FIG. 3, the ITO electrode 102, the fluorescent layer 104 and the aluminum reflective film 108 are formed on the glass front substrate 101 in sequence.

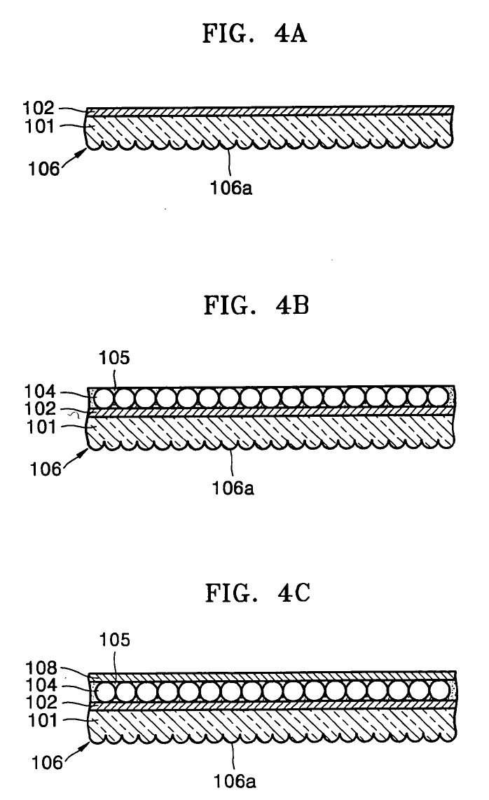

FIGS. 4A through 4C are schematic cross-sectional views of a process of producing the front substrate 101.

First, referring to FIG. 4A, a convex portion 106 is formed on a first surface of a glass substrate 101 and an ITO electrode 102 is coated on a second surface of the glass substrate 101. The convex portion 106 can be formed on the first surface during the process of producing the glass substrate. Alternatively, a polyester film having convex projections 106a on its surface can be attached to the first surface of the glass substrate.

Then, referring to FIG. 4B, a fluorescent layer 104 having a predetermined thickness, for example, a thickness of 10 μm, is coated on the ITO electrode 102. Then, the fluorescent layer 104 on the ITO electrode 102 is spin-coated with an adhesive 105. The adhesive 105 serves to attach the fluorescent layer 104 with the ITO electrode 102 and the aluminum reflective film 108 which will be described later.

Referring to FIG. 4C, the aluminum reflective film 108 is formed on the fluorescent layer 104 by a sputtering method.

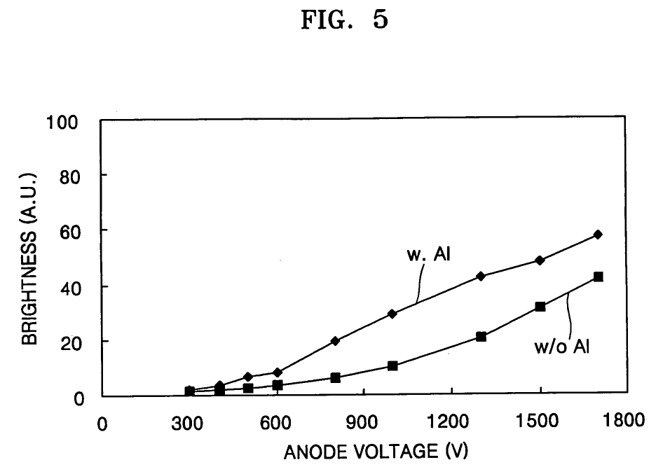

FIG. 5 is a graph of the experimental results showing the effect of an aluminum reflective film 108 on the enhancement of brightness.

Referring to FIG. 5, it can be seen that when a pulse voltage of 1.5 to 2.0 kV is supplied to an anode 102, the brightness is enhanced by about 30%.

The field emission backlight device according to the present invention has an improved luminance uniformity by forming a convex portion on one side of the front substrate and a reflective film on the other side of the front substrate. Thus, the use of a diffuser can be eliminated, thus reducing the production cost of the backlight device.

While the present invention has been particularly shown and described with reference to exemplary embodiments thereof, it will be understood by those of ordinary skill in the art that various changes in form and details can be made therein without departing from the spirit and scope of the present invention as defined by the following claims.

1. A field emission backlight device comprising:
a front substrate and a rear substrate arranged in parallel and spaced apart from each other by a predetermined distance;
an anode and a cathode arranged opposite to each other on respective inner surfaces of the front and rear substrates;
a fluorescent layer arranged on the anode and having a predetermined thickness;
a convex portion including a plurality of convex projections arranged on an outer surface of the front substrate opposite to the anode; and
electron emitters arranged on the cathode to emit electrons in response to an applied field.

2. The field emission backlight device of claim 1, further comprising a reflective film arranged on the fluorescent layer to reflect light generated by the fluorescent layer towards the front substrate.

3. The field emission backlight device of claim 1, wherein the convex projections have a size of several tens μm to several tens nanometers.

4. The field emission backlight device of claim 1, wherein the convex portion comprises a film having a plurality of convex projections attached to the outer surface of the front substrate.

5. The field emission backlight device of claim 2, wherein the reflective film is aluminum.

6. The field emission backlight device of claim 5, wherein the reflective film has a thickness of 500 Å.

7. The field emission backlight device of claim 1, wherein the electron emitters comprise Carbon NanoTube (CNT) materials.
